(19) United States
(12) Patent Application Publication
(10) Pub. No.: US 2009/0217185 A1
(43) Pub. Date: Aug. 27, 2009

(54) CONTAINER GENERATION SYSTEM FOR A CUSTOMIZABLE APPLICATION

(76) Inventor: EUGENE GOLDFARB, Whitehouse Station, NJ (US)

Correspondence Address: ACCENTURE INDY 33391;BRINKS HOFER GILSON & LIONE, CAPITAL CENTER, SUITE 1100, 201 NORTH ILLINOIS STREET, INDIANAPOLIS, IN, 46204-4220, US

(21) Appl. No.: 12/036,119

(22) Filed: Feb. 22, 2008

(51) Int. Cl. G06F 3/048

(52) U.S. Cl. 715/763

(57) ABSTRACT

A container generation device may create an association between questions and a container in an application database so that a customizable application displays a section in a page of the customizable application and displays user input controls in the section, where the section corresponds to the container and the user input controls correspond to the associated questions. The container generation device may also create an association between questions and question display rules, where the question display rules are expressions, and the expressions include answers to questions as operands. The customizable application may display a user input control that corresponds to a question if a question display rule associated with the question evaluates to a predetermined condition.

### REFERENCE TO RELATED APPLICATIONS

The following co-pending and commonly assigned U.S. patent applications have been filed on the same date as the present application: U.S. patent application Ser. No. ______, “A Conversational Question Generation System Adapted for an Insurance Claim Processing System,” (Attorney Ref. No. 10022/1099), filed herewith, U.S. patent application Ser. No. ______, “A Rule Generation System Adapted for an Insurance Claim Processing System,” (Attorney Ref. No. 10022/1159), filed herewith, and U.S. patent application Ser. No. ______, “Page Navigation Generation System for a Customizable Application”, (Attorney Ref. No. 10022/1161), filed herewith, all of which are herein incorporated by reference.

### BACKGROUND

1. Technical Field

This application relates to customizable software applications, and in particular, to a container generation system for customizing a display page of a customizable software application.

2. Related Art

In processing insurance claims from an insurance customer, an insurance claim adjuster typically asks a variety of questions from the insurance customer. An insurance claim processing center may employ an insurance claim processing application for processing insurance claims from insurance customers. The insurance claim processing application may be used by various employees at the claim processing center such as insurance claim adjusters. The insurance claim processing application may be configured to display various graphical user interfaces, or pages, that an insurance claim adjuster uses when asking questions to an insurance customer and when the insurance claim adjuster receives answers to those questions. In some implementations, the various pages may be connected such that the question and answer session between the insurance claim adjuster and the insurance customer follows a logical progression based on the answers the insurance claim adjuster receives.

In some circumstances, the insurance claim processing center may want to add or modify existing questions for the insurance claim adjuster to ask of the insurance customer. In addition to adding or modifying the questions themselves, the insurance claim processing center may want to modify the conditions that determine when to display one or more of the questions. For example, the insurance claim processing application may want to display a question about vehicle repair costs only if a vehicle sustained damage in an accident.

In some instances, the insurance claim processing center may want to modify conditions that determine when to display a group of the questions on a page. For example, if a state passes a new law that applies to a particular kind of accident occurring in that state, the insurance claim processing center may want to display a group of questions relating to the application of the new law only if the accident occurred in that state and only if the accident was of the particular kind covered by the new law. Thus, the insurance claim processing center may want to re-configure the page.

In still other scenarios, the insurance claim processing center may want to override properties of a question. For example, a newly enacted law may require that a question be answered by an insurance claim adjuster that previously was optionally answered. Where the insurance claim adjuster used to be able to skip over the question, the insurance claim adjuster would now be required to answer the question before proceeding.

However, an insurance claim processing application is usually extremely complex. Therefore, changes to the claim processing application require the help of an individual, such as a computer program developer, that has a skill set that includes the computer programming language in which the insurance claim processing application was written. Hence, the insurance claim processing center incurs additional burdens, including fees to the computer program developer and lag time in introducing modifications. In addition, when an insurance claim processing center does not have the personnel with the technical skill set to make a modification, the insurance claim processing center must incur additional time and expenses in training or hiring the personnel with the requisite skill set.

Moreover, making modifications to existing insurance claim processing applications may require disabling access to and shutting down the systems connected to the insurance claim processing application. This shutting down process results in downtime of the insurance claim processing center, which translates into lost revenue and lost worker productivity.

Accordingly, there is a need for a system that efficiently modifies an insurance claim processing application without requiring specialized skills.

### SUMMARY

A container generation system may create an association between questions and a container in an application database so that a customizable application displays a section in a page of the customizable application and displays user input controls in the section. The section corresponds to the container and the user input controls correspond to the associated questions. The container generation system may alter the order that the user input controls are displayed in the section by altering the order of the questions associated with a container in the application database. The container generation system may limit access to the container generation system to a user that has a predefined security privilege.

The application database may include a question detail entry that is manually configurable to customize a user input control that corresponds to a question. In particular, the question detail entry may contain user input control configuration parameters that configure the display and behavior of the user input control. The application database may also include a container detail entry that includes user input control configuration parameters, which override how the user input control behaves and is displayed in a section that includes the user input control. The container generation system may generate the container detail entry based on user input control configuration parameters selected by a user.

A container generation device may also create an association between questions and question display rules in the application database, where the question display rules may be Boolean expressions. The Boolean expressions may include, as operands, answers to questions. In some examples, the customizable application may only display a user input control that corresponds to a question if a question display rule associated with the question is true.

The question display rule may be configured with a question display rule entry in the application database. The container generation device may also receive user modifications of the question display rule and generate the question display rule entry to reflect the user modifications.

Further objects and advantages of the present invention will be apparent from the following description, reference being made to the accompanying drawings wherein preferred embodiments of the present invention are clearly shown.

### BRIEF DESCRIPTION OF THE DRAWINGS

The innovation may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is an illustration of an example of an insurance related processing application implemented with a customizable application.

FIG. 2 is an illustration of an example of a container generation system.

FIG. 3 is an illustration of various modules included in the container generation code of FIG. 2 in communication with an application database.

FIG. 4 is an illustration of an example of a screen implemented by the user interface module of FIG. 3.

FIG. 5 is an illustration of an example of a screen implemented by the user interface module of FIG. 3 to associate an active question with a container.

FIG. 6 is an illustration of an example of a screen implemented by the user interface module of FIG. 3 to edit a container.

FIG. 7 is an illustration of an example of a screen implemented by the user interface module of FIG. 3 to associate display rules with a container.

FIG. 8 is an illustration of an example of a screen implemented by the user interface module of FIG. 3 to override user input control configuration parameters.

FIG. 9 is a flow diagram illustrating an example operation of a graphical user interface for configuring a customizable application to associate at least one question with a container.

### DETAILED DESCRIPTION

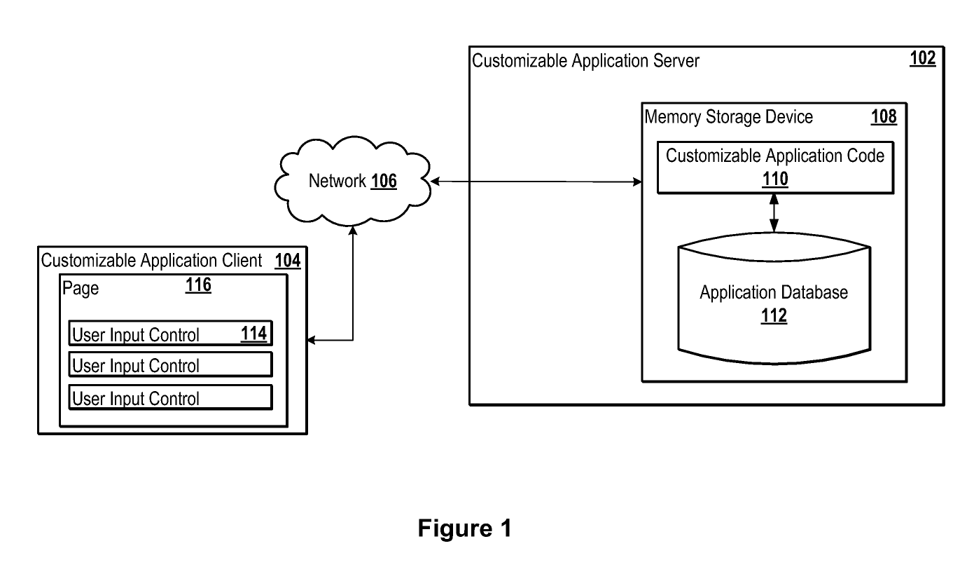

FIG. 1 is an example of an insurance related processing application implemented with a customizable application. The customizable application is a software application designed for software program developers to modify the behavior of the insurance related processing application. The insurance related processing application may be, for example, an insurance claim processing application, an insurance underwriting application or any other insurance related application used to conduct insurance related business. It should also be recognized that the system is not limited to insurance related applications and can instead be applied in any customizable application. The customizable application may include at least one customizable application server 102 and at least one customizable application client 104, both connected by a network 106. The customizable application server 102 may be any number of computers connectable to the network 106, and may include at least one memory storage device 108 that includes customizable application code 110 and an application database 112. The customizable application client 104 may be any number of computer or terminals connectable to the network 106. The application client 104 may communicate with the customizable application server 102 over the network 106 using any communication protocol, such as HTTP, HTTPS, WAP, etc. The network 106 may be any form of LAN, WAN, etc., including wireless and wire line networks.

The memory storage device 108 may be any kind of memory storage device or a combination of different kinds of memory or memory storage devices including, but not limited to, random access memory (RAM), read-only memory (ROM), hard disk, optical disk, digital video disk (DVD), compact disk read-only memory (CD-ROM), etc. The customizable application code 110 may be any computer code written in any computer language, such as Java, C++, C#, C, Visual Basic, Java Script, Perl, etc.

The application database 112 may be any electronic collection of information that is organized so that it can be accessed, managed, and updated, such as a Relational Database Management System (RDBMS), an object-oriented database, an extensible markup language database (XML), a file system, etc. The application database 112 may be configurable to customize certain aspects of the customizable application client 104. The application database 112 may include database entries that correspond to one or more aspects of the customizable application. By configuring the database entries, aspects of the customizable application that correspond to the database entries are customized. A database entry is information that may be retrieved from the application database 112 using a unique key, such as a primary key value, a full path name, or an XML Path Language (XPATH) expression. The database entry may be stored in multiple locations in the application database 112, such as in multiple tables in an RDBMS.

The customizable application code 110 may read the database entries to determine how to perform certain aspects of the customizable application. For example, the application database 112 may contain a database entry that is read and used by the customizable application code 110 to display a corresponding user input control 114 on a page 116, which is displayed at the customizable application client 104.

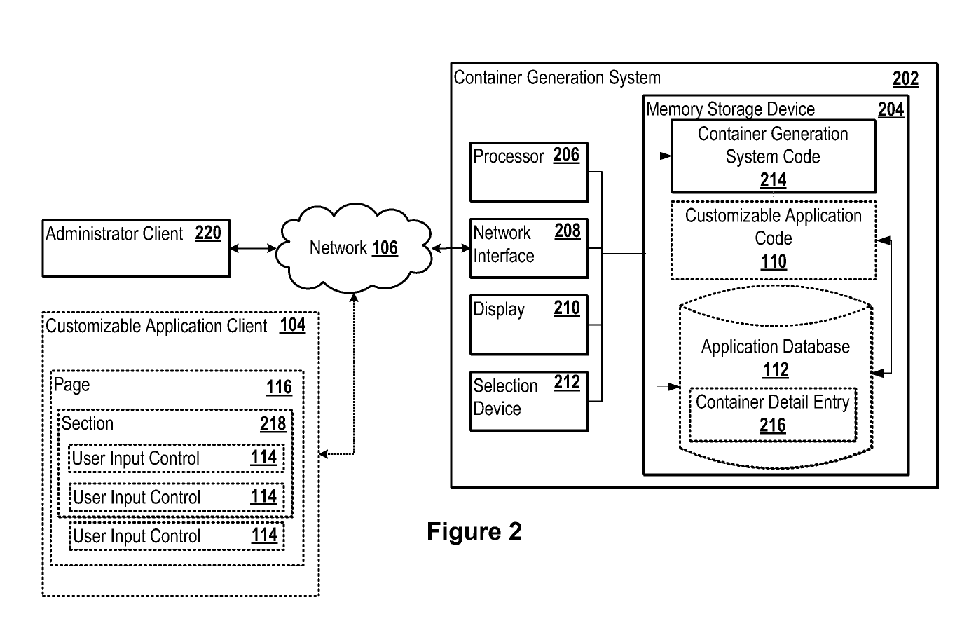

FIG. 2 is an example of a container generation system. The container generation system 202 may include one or more of a memory storage device 204, a processor 206, a network interface 208, a display 210 and a selection device 212. An administrator of the customizable application may customize some aspects of the customizable application by using the container generation system 202.

The processor 206 may be any device or system capable of performing logic operations, analog or digital. The processor 206 is interconnected to the network interface 208. The network interface 208 connects the container generation system 202 with a network 106. The processor 206 is further electrically connected to the display 210. The display 210 is any electro-optical device for displaying data, such as a liquid crystal display (LCD), a cathode ray tube (CRT) display, an electro-luminescent display, a plasma display panel (PDP), a vacuum florescent display (VFD), etc. The selection device 212 may be any user input device such as a mouse, touchpad, microphone, or any other mechanisms and/or systems that provide a communication path to exchange data between users and systems.

The memory storage device 204 may be any kind of memory storage device or a combination of different kinds of memory or memory storage devices including, but not limited to, random access memory (RAM), read-only memory (ROM), hard disk, optical disk, digital video disk (DVD), compact disk read-only memory (CD-ROM), etc. The memory storage device 204 may contain container generation code 214 which may be computer code written in any computer language, such as Java, C++, C#, C, Visual Basic, Java Script, Perl, etc. The container generation code 214 is executable with the processor 206.

In some examples the memory storage device 204 may also include an application database 112. The 112 be any electronic collection of information that is organized so that it can be accessed, managed, and updated, such as a Relational Database Management System (RDBMS), an object-oriented database, an extensible markup language database (XML), a file system, etc. The application database 112 may include database entries that correspond to some aspect of the customizable application. A database entry may be information that may be retrieved from the application database 112 using a unique key, such as a primary key value, a full path name, or an XML Path Language (XPATH) expression. A portion of the database entry may be stored in multiple locations in the application database 112, such as in multiple tables of an RDBMS.

The application database 112 is configurable to customize the customizable application. An administrator interacting with the container generation system 202 through the selection device 212 and the display 210 can direct the container generation code 214 to modify database entries in the application database 112 to customize the customizable application.

In some examples, the memory storage device 214 may also contain customizable application code 110. The customizable application code 110 may be computer code written in any computer language, such as Java, C++, C#, C, Visual Basic, Java Script, Perl, etc. In other examples, the customizable application code 110 is stored and executed on a different computer.

The customizable application code 110 communicates through the network interface 208 and over the network 106 with a customizable application client 104. The communication may be done in any number of protocols such as HTTP, HTTPS, WAP, SOAP, etc. The customizable application client 104 is a computer or terminal used by an insurance claim adjuster to interact with the customizable application. The customizable application may include a page 116, which may be one of many display pages or screens in the customizable application. Based on database entries stored in the application database 112, the customizable application code 110, alone or in conjunction with additional computer code executing at the customizable application client 104, is executable to display the display pages.

The application database 112 may include a container detail entry 216, which may be a database entry. The container detail entry 216 may correspond to a section 218 of the page 116. The section 218 may include a user input control 114. The section 218 also may include additional input controls. The user input control 114 may be any type of user interface element that is used to obtain input from a user, such as a text box, a scrollable text box, a radio button group, a check box, a button, etc. The section 218 may be any type of user interface element that may include user input controls. For example, the section 218 may be a <DIV> element in Hypertext Markup Language (HTML), a <FRAME> element in HTML, a Panel control in Visual Basic, etc. The section 218 may be configurable with the information contained in the container detail entry 216. Each user input control 114 included in section 218 may be configurable with a corresponding question detail entry stored in the application database 112.

The container generation system 202 may be any number of computers connectable to the network 106. An administrator client 220 may be any number of computer or terminals connectable to the network 106. The administrator client 220 may communicate with the container generation system 202 over the network 106 using any communication protocol, such as HTTP, HTTPS, WAP, etc. The network 106 may be any form of LAN, WAN, etc., including wireless and wire line networks. An administrator of the customizable application may use the administrator client 220. However, any user may use the administrator client 220.

In other examples, the customizable application code 110 and the application database 112 are not included in the memory storage device 204 of the container generation system 202. Instead, the container generation system code 214 may access the application database 112 over the network 106 through the network interface 208. The customizable application code 110 may also be stored and executed on one or more computers or servers different than the container generation system 202.

In some examples, the container generation system 202 may also not include the display 210 and the selection device 212. Instead, the administrator client 220 may include the display 210 and the selection device 212. In alternative examples, all or part of the container generation system code 214 may execute at the administrator client 220, where the administrator client 220 may include the display 210 and the selection device 212.

The administrator may use the administrator client 220 in the container generation system 202 to generate or modify the container detail entry 216 in the application database 112. An insurance claim adjuster may view the page 116 at the customizable application client 104. The section 218 is configured according to the container detail entry 216. Thus, the administrator, through the administrator client 220, can customize the customizable application used by the insurance claim adjuster.

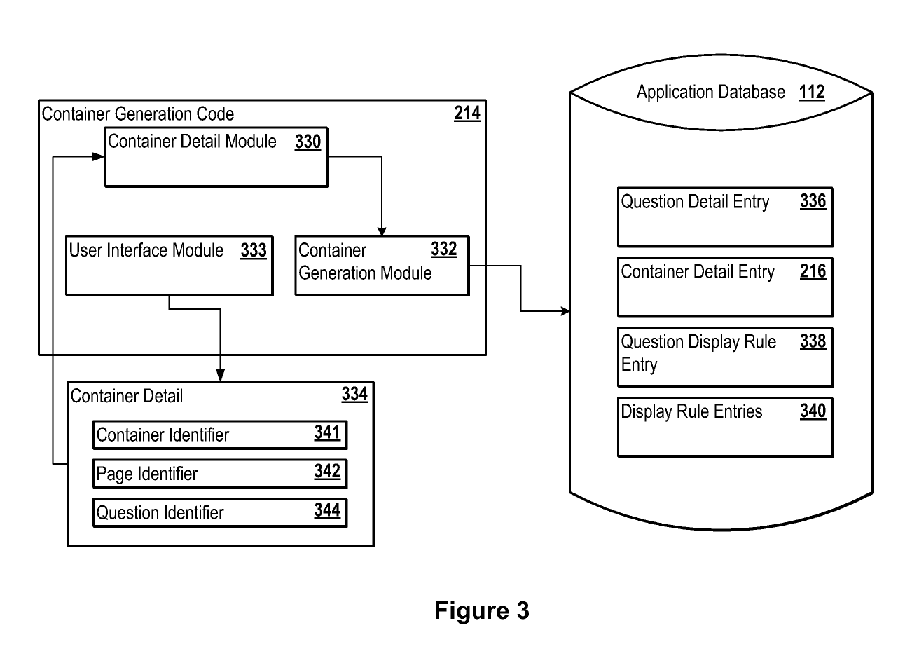

FIG. 3 is an example of various modules included in the container generation code of FIG. 2 in communication with an application database 112. Container generation code 214 may include a container detail module 330, a user interface module 333 and a container generation module 332. The modules described are one example of the functionality described. In other examples, the described functionality may be described in fewer or greater numbers of modules. The container detail module 330, the container generation module 332, and the user interface module 333 include computer code. The container detail module 330 is executable to receive a container detail 334. The container detail 334 contains parameters. Based on the parameters of the container detail 334, the container generation module 332 may create or modify the container detail entry 216 in the application database 112. The user interface module 333 communicates with a user of the container generation system to create the container detail 334.

The container detail module 330 is executable to receive the container detail 334 from any number of possible sources. For example, the container detail module 330 may receive the container detail 334 from the user interface module 333. In another example, the container detail module 330 may receive the container detail 334 from computer code executable to retrieve data stored in an XML file. In still another example, the container detail module 330 may receive the container detail 334 from a network using a protocol such as SOAP.

The application database 112 may contain database entries to configure the customizable application. For example, the application database 112 may include a question detail entry 336, the container detail entry 216, a question display rule entry 338, and a display rule entries 340. In other examples, any number of database entries may be included in the application database 112.

A question may have an answer that a user of the customizable application inputs into the system. The question may be posed to the user and the answer may be any information provided by the user in response to the question. The answer may be posed to the user using, for example, a user input control 114. The answer may be entered in the form of a predetermined data type such as text, numeric, etc. The customizable application may use the question detail entry 336 to configure the user input control to be displayed on a page of the customizable application, such as a user input control to obtain an answer to a question. For example, the question detail entry 336 may include user input control configuration parameters, such as, a default value, a display length, a label, a read-only flag, a control type, etc. If the default value is set and no value is associated with the answer to the question in the application database 112, then the customizable application may set a value of the user input control to the default value. The display length may indicate how many characters will be displayed in the user input control. The label may be text of the question and the customizable application may display the label next to the user input control. If the read-only flag is set to true, then the customizable application may display, but disable the user-input control. The control type may indicate the type of user input control to display, such as a text box, a scrollable text box, a radio button group, a check box, a button, etc. The control type used may depend on the data type of an expected answer to the question.

The customizable application may use the container detail entry 216 to configure a section of a page of the customizable application. For example, the container detail entry 216 may include a unique key associated with the question detail entry 336. In this manner, the question detail entry 336 is said to be associated with the container detail entry 216, i.e., associated with the container. More generally, the container detail entry 216 may include unique keys, each associated with a different question detail entry 336. The customizable application may display the user input controls that correspond to the question detail entries associated with the container.

The customizable application may use the question display rule entry 338 to configure a question display rule that determines whether the input control is displayed on the page. The question display rule corresponding to the question display rule entry 338 may be a Boolean expression, where operands of the Boolean expression include expressions of variables to be evaluated by the customizable application. For example, the question display rule may be “accidentInvolvesInjuries and vehicleDamage>‘1000’”. In this example, the question display rule is a Boolean expression having two variables: accidentInvolvesInjuries and vehicleDamage. The example question display rule is true only if the first variable is true and the second variable is greater than 1000. The variables may refer to answers to questions identified by the variables names.

The question display rule entry 338 may include a question display rule name. In some examples, the question display rule name may be the Boolean expression that is the question display rule. In other examples, the question display rule name may merely be a display rule name of a display rule that is itself a Boolean expression. In still other examples, the question display rule name of the question display rule may be a Boolean expression having operands that are display rule names of display rules.

Any manner of associating two database entries in the application database 112 may be used to associate the question display rule entry 338 with the question detail entry 336. In some examples, the question display rule entry 338 is associated with the question detail entry 336 by including a unique key associated with the question detail entry 336 in the question display rule entry 338. In other examples, the question display rule entry 338 is associated with a question detail entry 336 by including a unique key associated with the question display rule entry 338 in the question detail entry 336. In still other examples, the question display rule entry 338 is associated with a question detail entry 336 by including a unique key associated with the question display rule entry 338 and a unique key associated with the question detail entry 336 in the container detail entry 216.

Once the question display rule entry 338 is associated with the question display rule, the customizable application may display the user input control that corresponds to the question detail entry 338 if the question display rule corresponding to the question display rule entry 338 evaluates to a predetermined value, such as “true” or “false”. In some examples, the section of the page may not be displayed if no user input controls included in that section are displayed. In some examples, a display rule may be associated with the container itself, and the customizable application will display the section (and any included user input controls) only if the display rule evaluates to a predetermined value, such as “true” or “false”.

As previously discussed, the user interface module 333 may obtain input from a user of the container generation system to create the container detail 334. In order to determine, or to assist the user to determine what parameters to include in the container detail 334, the user interface module 333 may access the application database 112 to retrieve the question detail entry 336, the container detail entry 216, the question display rule entry 338 and/or the display rule entries 340.

The container detail 334 may include parameters used by the container generation module 332 to generate the container detail entry 216. For example, the container detail 334 may include a page identifier 342 and a question identifier 344. The page identifier 342 identifies the page that includes the section that corresponds to the container detail entry 216. Similarly, the question identifier 344 identifies a question detail entry 336 that corresponds to the user input control included in the section.

The container detail 334 may alternatively contain a set of question identifiers corresponding to question detail entries 336 to be associated with the container. In some examples, the set of question identifiers may be an ordered set. In such an example, the order of the user input controls as displayed in the section will depend on the order of the question identifiers in the container detail 334 and the order of the question detail entries 336 as associated with container detail entry 216.

The container detail 334 also may include a container identifier 341 to uniquely identify each of the containers. The container generation module 332 may overwrite or modify an existing container detail entry 216 identified by the container identifier 341. Alternatively, the container generation module 332 may create a new container detail entry 216 in the absence of a container identifier 341 in the container detail 334.

The container detail module 330 can additionally call a security layer to perform a security check to ensure that the current user executing the container detail module 330 has the correct privileges necessary to generate the container detail entry 216. For example, the current user executing the container detail module 330 may be required to be a member of a security group such as an administrator group. In other examples, the current user executing the container detail module 330 may not be required to be a member of the security group.

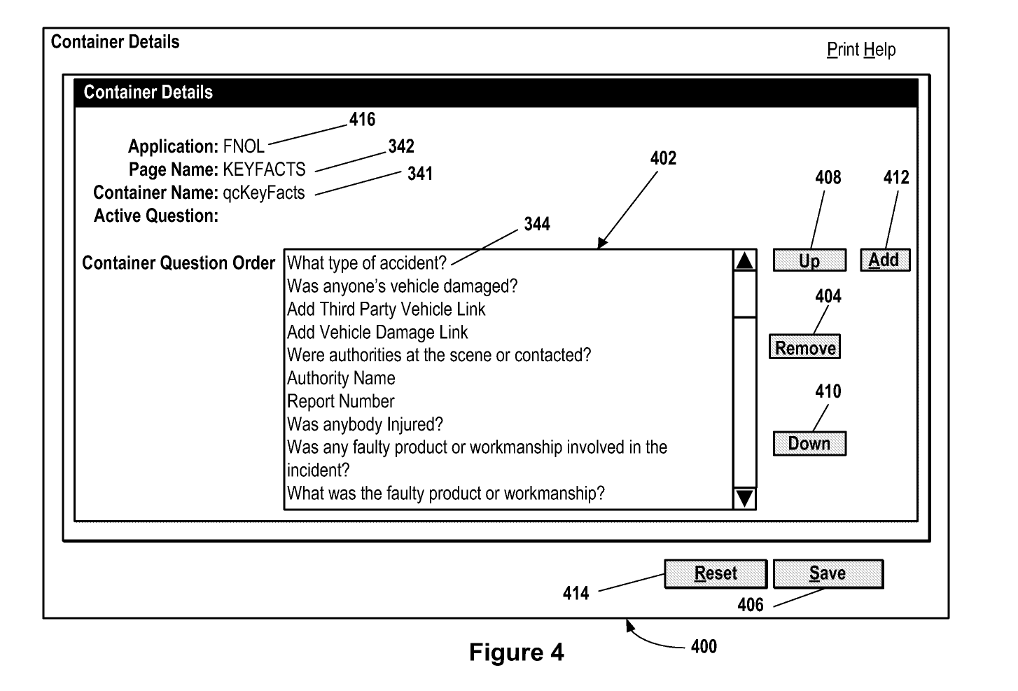

FIG. 4 is of an example of a screen generated with the user interface module 333 of FIG. 3. Portions of a container detail 334 are displayed in a window 400 on the screen. The screen may be generated on the administrator client 220 or the display 210 (FIG. 2). In this example, a page identifier 342 is displayed in the window 400 and a container identifier 341 is also drawn on the window 400. The user interface module 333 has also displayed a set of question identifiers 344 in a scrollable text box 402 in the window 400. In other examples, another format or configuration of a screen including similar functionality may be generated.

Referring to FIGS. 3 and 4, during operation, a user may select a question identifier 344 with a selection device. The user may then select a remove button 404. If the user then presses a save button 406 with the selection device, then the user interface module 333 prepares a container detail containing a set of the question identifiers 344 minus the question identifier removed when the user selected the remove button 404. The container detail module 330 may then receive the container detail and the container generation module 332 may generate a new or updates an existing container detail entry. In other examples, any other form of mechanism may be used to select and remove question identifiers such as, selecting with keyboard shortcuts in conjunction with pressing a delete key, selecting with a mouse and then making a menu selection, etc.

In another example, the user may select a question identifier 344 in the scrollable text box 402 and then press an up button 408 or a down button 410 to change the order of the question identifier 344 in the set of question identifiers. The user interface module 333 will display the set of question identifiers 344 in the order as altered by the user through the selection of the up button 408 or the down button 410 using the selection device. In other examples, any other mechanism may be used such as selecting using keyboard shortcuts and then pressing arrow keys, etc.

The user may select an add button 412 with the selection device. Selecting the add button 412 may cause the user interface module 333 to draw a new window permitting the user to search for, or select from, a list of question identifiers not yet in the set of question identifiers 344 displayed in the scrollable text box 402. In other examples, any other mechanism may be used such as making a menu selection, using speech commands, etc.

During operation, after the user interface module 333 receives a selection of the save button 406, the user interface module 333 may reflect any changes made in the container detail 334, and received by the container detail module 330. Subsequently, the container generation module 332 may generate the container detail entry from the container detail 334. If the container identifier 341 already exists in the container detail entry 216, then the container generation module 332 may overwrite or modify the existing container detail entry 216.

The user interface module 333, when first displaying the window 400, may save a copy of the container detail 334. Should a reset button 414 subsequently be selected by the user with the selection device, the user interface module 333 may re-draw the window 400 with the information from the saved copy of the container detail.

If the customizable application supports multiple applications from the application database 112, then the user interface module 333 may display an application identifier 416 on the window 400. In one example, the customizable application may support a first notice of loss application (FNOL) and an underwriting application. In other examples, any combination of insurance related applications or other customizable application may be supported, such as an underwriting application and an application unrelated to the insurance field.

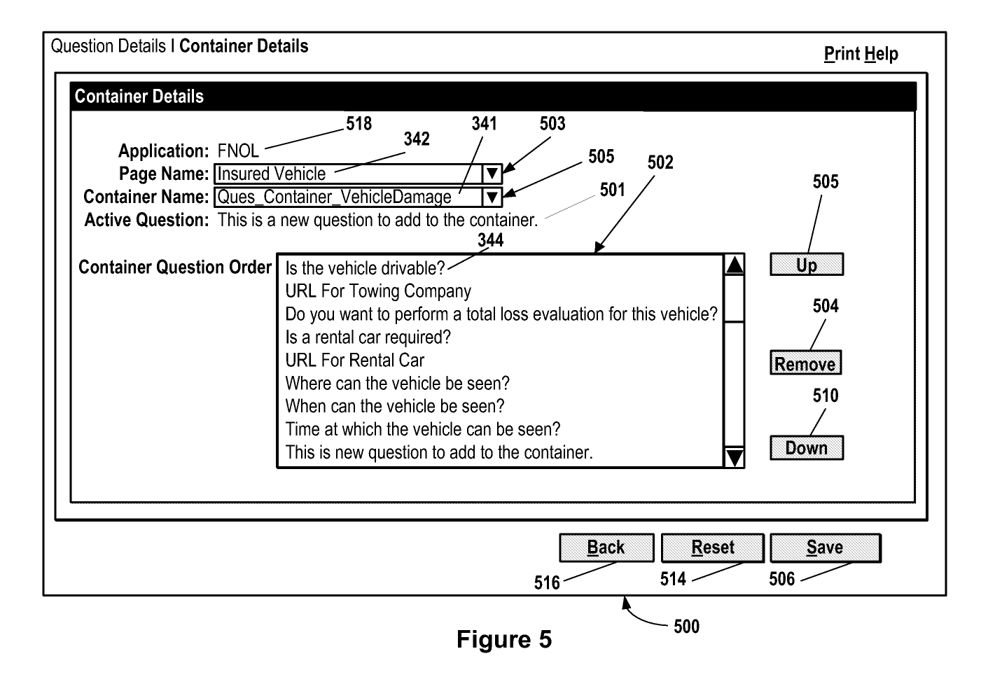

FIG. 5 is an example of a screen 500 implemented by the user interface module of FIG. 3 to associate an active question with a container. An active question is merely a question that the user was viewing in a prior screen. The active question may be a newly created question, or a question that already exists in the application database 112. In this example, during operation the user has previously navigated from the prior screen that displayed information about a question, where that question is identified by an active question identifier 501. The user may select a page identifier 342 from a list box 503. However, any manner of selection from a list may be used. For example, one method would be to display a dialog box and to permit the user to enter a query to search for a particular page identifier. Similarly, the user may select a container identifier 341 from a second list box 505. Again, any manner of selection from a list may be used.

After the user has selected the page identifier 342 and the container identifier 341, the user may select a save button 506. In such a case, the user interface module 333 may create a container detail 334 containing the page identifier 342, the container identifier 341 and a set of question identifiers that includes the question identifiers 344 displayed in a list box 502 as well as the active question identifier 501. The user interface module 333 may prevent the user from removing a question identifier 344 with a remove button 504 if the question identifier 344 is the same as the active question identifier 501.

The order of question identifiers may be altered by selecting a question identifier 344, and then selecting either an up button 505 or a down button 510. If the user selects a back button 516 instead of the save button 506, then the user may be returned to the prior screen that displayed information about the question identified by the active question identifier 501. The user may select a reset button 514 to rollback any unsaved questions. As previously discussed, the functionality to save, remove, order, etc. may be implemented differently in other examples.

If the customizable application supports multiple applications from the application database 112, then the user interface module 333 may display an application identifier 518 in the screen 500. In one example, the customizable application may support a first notice of loss application (FNOL) and an underwriting application. In other examples, any combination of insurance related applications or other customizable application may be supported, such as an underwriting application and an application unrelated to the insurance field.

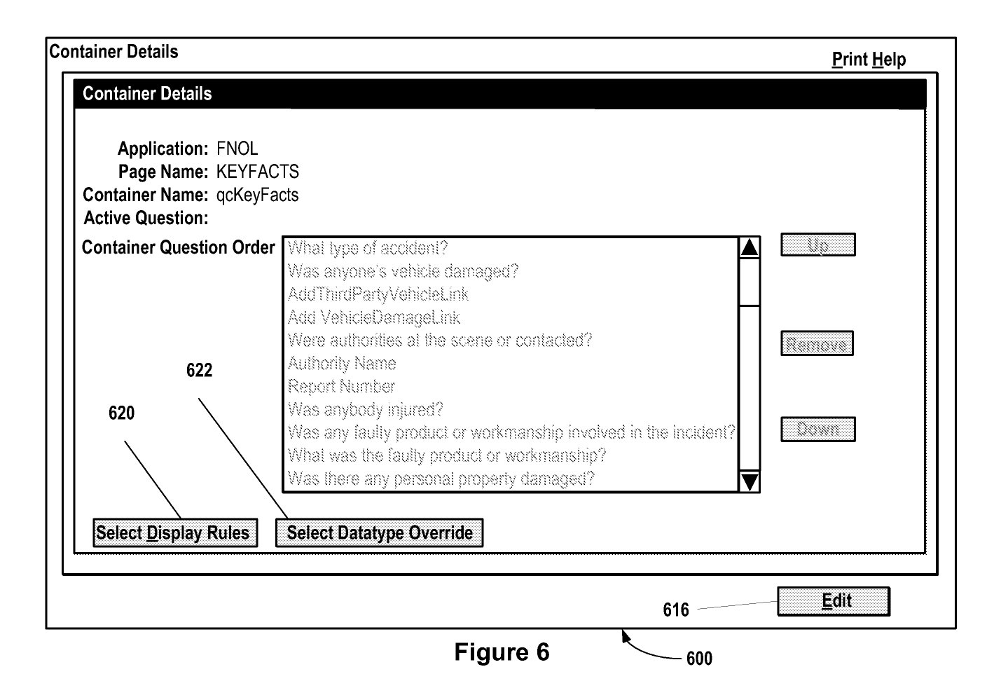

FIG. 6 is an example of a screen implemented by the user interface module 333 of FIG. 3 to edit a container. A window 600 may contain an edit button 616. During operation, a user may select the edit button 616 before proceeding to a screen such as the screens shown in FIG. 4 and FIG. 5.

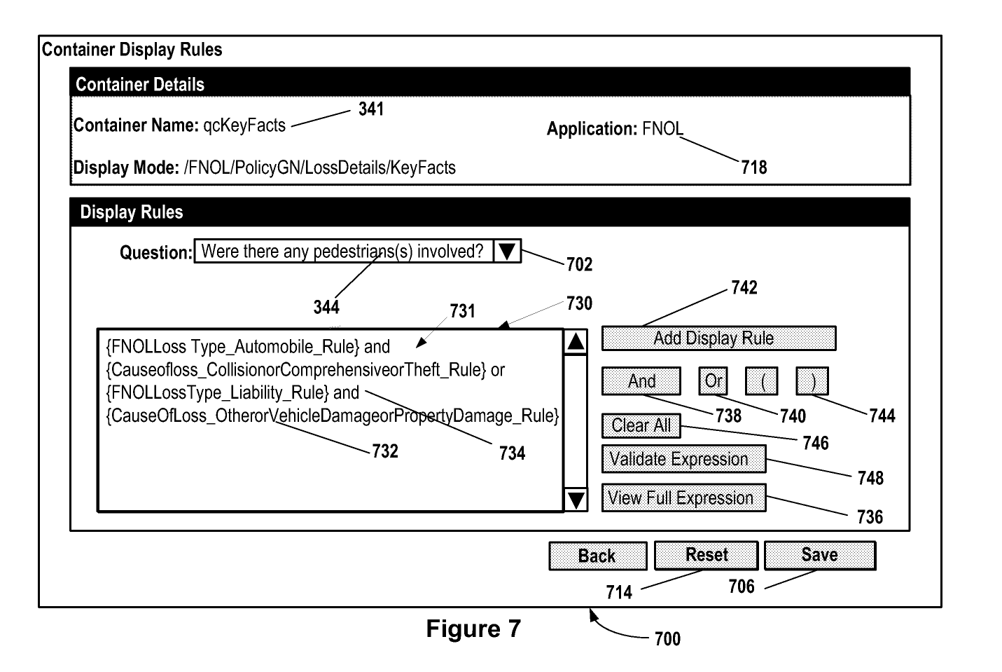

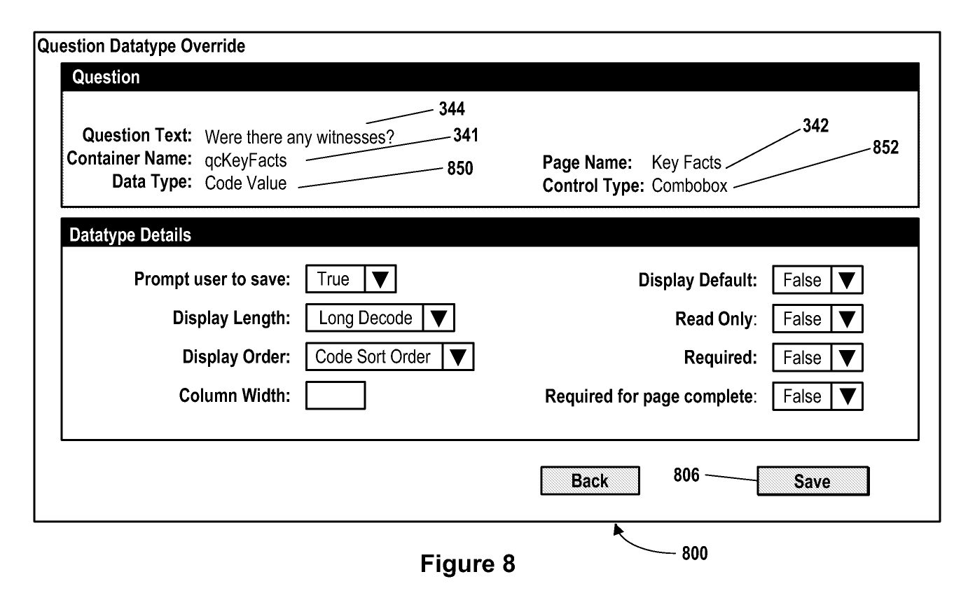

The window 600 may also contain a select display rules button 620 and a select datatype override button 622. During operation, if a user selects the select display rules button 620 then the user interface module 333 may implement display of a new screen to select and modify display rules associated with a container such as the screen shown in FIG. 7. If a user selects the select datatype override button 622, the user interface module 333 may implement display of a new screen that permits the user to override user input control configuration parameters of a particular question associated with the container, such as the screen shown in FIG. 8.

FIG. 7 is an example of a screen implemented by the user interface module 333 of FIG. 3 to associate display rules with a container. A window 700 may contain a container identifier 341. The window 700 may also contain a list box 702 to select a question identifier 344. A question display rule may be associated with a question identified by the question identifier 344. The window 700 may also contain a text box control 730. A question display rule name 731 of the question display rule may be displayed in the text box control 730. In one example, the question display rule name 731 may be a Boolean expression. The Boolean expression may include display rules as operands of Boolean operators. Each display rule may be represented by a rule name 732 and combined using a Boolean operator 734 to other display rules. In other examples, the display rule name 731 may be any other form of logic function or expression.

During operation, if a user selects a different question identifier 344 using the list box 702, the text box control 730 displays a question display rule name 731 associated with that different question identifier 344 if any question display rule were associated with a question identified by the new question identifier 344. By selecting with the list box 702, any one of the questions associated with the container identified by container identifier 341, the user can view any rule associated with questions associated with the container.

A user may also save any changes made in the window 700 by selecting a save button 706. Alternatively, the user may select a reset button 714 to rollback any changes made before the last save.

A display rule may be displayed by simply displaying the rule name 732 of the display rule. In some examples, a user may select a view full expression button 736. In response, the user interface module 333 may display the Boolean expression of each display rule instead of just the rule name 732 of each display rule, and further include the Boolean operators 734, or other logic associated with the question display rule name 731.

During operation, in one example, to modify the question display rule, the user may place a selection device at a position in the Boolean expression displayed in the text box control 730, and then select an “And” button 738. The “And” button 738 will add the Boolean “and” operator where the cursor is currently positioned. Alternatively, the user may select an “or” button 740 and the Boolean operator “or” will be inserted at the cursor position. In other examples, any other logic functionality may be similarly implemented.

The user also may select an add display rule button 742 to select from a list of display rules that may be added at the selection device position. In some examples, the user may select a parenthesis button 744 to insert a parenthesis at the current location of the selection device. In yet another example, a user may select a clear all button 746 to clear all display rules currently associated with the question identified by the question identifier 344. In yet another example, the user may be able to enter free form text in the text box control 730.

In some examples, the window 700 may include a validate expression button 748. If a user selects the validate expression button 748, the user interface module 333 may perform validation of the logic or expression contained in the text control box 730. In one example, the user interface module may perform a syntactical validation of a Boolean expression. In other examples, the user interface module may perform more complex validation of the logic or expression in text box control 730. For example, in some customizable applications, the question display rule, when viewed as a full expression, is an XPATH expression to be applied to XML. In such an example, the user interface module may validate the XPATH expression against XML with a determined structure to calculate whether the XPATH was operating on nodes that could be queried by the XPATH expression.

If the customizable application supports multiple applications from the application database 112, then the user interface module 333 may display an application identifier 718 in the window 700. In one example, the customizable application may support a first notice of loss application (FNOL) and an underwriting application. In other examples, any combination of insurance related applications or other customizable application may be supported, such as an underwriting application and an application unrelated to the insurance field.

FIG. 8 is an example of a screen implemented by the user interface module of FIG. 3 to override user input control configuration parameters. In some examples, a customizable application may permit the same question to be displayed on different pages. The customizable application may be configurable to modify the user input control configuration properties associated with that question depending on the page the user input control or question is displayed on. In the example of FIG. 8, the window 800 permits a user to modify the user input control configuration properties of a question detail entry specifically for a particular page and, more specifically, for a particular container. The window 800 may include a container identifier 341, a page identifier 342, and a question identifier 344.

The window 800 may also include a datatype 850 of an answer to a question identified by the question identifier 344. The window 800 may additionally include a control type 852 of the user input control corresponding to the question identified by the question identifier 344. For example, a control type may be a radio group button, a text box, a scrollable text box, etc. The user input control configuration parameters of the user input control that may be overridden for the question identified by the question identifier 344 may also be shown in window 800. During operation, if the user selects a save button 806, the user interface module 333 may prepare a container detail 334. The container detail 334 may be received by the container detail module 330 and used by the container generation module 332 to modify or create the container detail entry 216.

Examples of user input control configuration properties that may be overridden can include, but are not limited to a prompt to save, a display length, a display order, a column width, a display default flag, a read-only flag, a control-level flag, and a page-level flag. For example, prompt to save, when set, may indicate to the customizable application that if the answer field in the user input control has been modified in this session then the customizable application may prompt the user to save changes before navigating from the page. The display length may indicate how many characters will be displayed in the user input control. The display length may be less than the total amount of characters that may be stored in the answer associated with a question. A display order may indicate the order in which a list of values should be displayed, where the list of values is a list of permissible answers to the question. Setting the column width to some value may permit a user to limit the number of characters that the user can actually enter in the user input control. The display default flag may indicate that a default value from a list of values will automatically be populated in the user input control. The read-only flag, when set, may indicate that the user input control is displayed, but not enabled (i.e., “grayed out”). The control-level flag, when set, may indicate that the user may not change focus from the user input control unless a value is first entered in the user input control. In contrast to the control-level flag, the page-level flag, when set, may permit the user to change the focus to a different user input control than the user input control associated with the question 344. However, in examples that include the page-level flag and the page-level flag is set, the user may not navigate away from the page unless a value is first entered in the user input control associated with the question 344. In some examples, the user input control configuration properties that may be overridden may vary depending on the data type of the question.

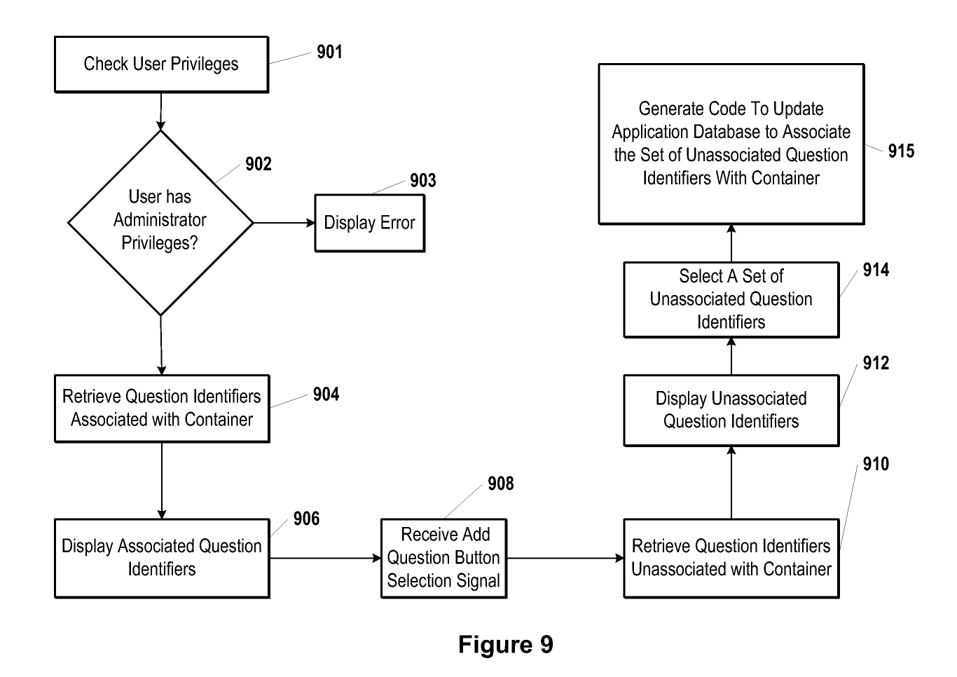

FIG. 9 is a flow diagram illustrating an example operation of a graphical user interface for configuring a customizable application to associate at least one question with a container. The graphical user interface may include a display and a selection device. As discussed previously, a user interface module may implement display of the graphical user interface.

The operation begins at block 901 by checking the user privileges. Checking the user privileges includes determining what security privileges the current user has. After proceeding to block 902, the next operation checks whether the current user has administrator privileges. If the user does not have administrator privileges, the operation proceeds to block 903 and displays an error message indicating that the current user does not have the appropriate privileges, halting the operation.

Alternatively, the operation may continue to block 904, and retrieve a first set of question identifiers that are associated with a container from an application database. The container may be a section of a page of the customizable application, and each of the question identifiers may identify questions represented by user input controls positioned within the section of the page.

The operation may continue to block 906, and display the first question identifier of the at least one of the questions of the first set on the display. In some examples, the operation may display all of the question identifiers in the first set.

At block 908 the operation, receives a button selection signal indicative of a selection device selecting an add question button. At block 910, the operation retrieves from the application database a second set of question identifiers unassociated with the container. The operation proceeds at block 912, to display on the display at least one of the question identifiers of the second set. In some examples, this operation includes displaying all of the question identifiers of the second set. At block 914, the operation receives a question selection signal indicative of the selection device selecting a third set of question identifiers from the second set.

The operation concludes at block 915, by updating the application database to associate the third set of questions with the container. In one example, updating the application database includes creating a container detail that includes the question identifiers of the first set and the question identifiers of the third set. Updating the application database may further include generating and executing database code that updates the application database so that the container detail entry includes the question identifiers included in the container detail.

All of the discussion, regardless of the particular implementation described, is exemplary in nature, rather than limiting. For example, although selected aspects, features, or components of the implementations are depicted as being stored in memories, all or part of systems and methods consistent with the innovations may be stored on, distributed across, or read from other machine-readable media, for example, secondary storage devices such as hard disks, floppy disks, and CD-ROMs; a signal received from a network; or other forms of ROM or RAM either currently known or later developed. Moreover, the various modules and screen display functionality is one example of such functionality and any other configurations encompassing similar functionality are possible.

Furthermore, although specific components of innovations were described, methods, systems, and articles of manufacture consistent with the innovation may include additional or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. Programs may be parts of a single program, separate programs, or distributed across several memories and processors.

While various embodiments of the innovation have been described, it will be apparent to those of ordinary skill in the art that many more embodiments and implementations are possible within the scope of the innovation. Accordingly, the innovation is not to be restricted except in light of the attached claims and their equivalents.

I claim:

1. A container generation system for a customizable application, the container generation system comprising:
a processor; and
a memory storage device comprising:
an application database configurable to customize the customizable application, the application database comprising:
a question detail entry to configure a user input control included in a section of a display page of the customizable application, wherein the customizable application includes at least two display pages; and
a container detail entry to configure the section of the display page, the container detail entry comprising a page identifier to identify the display page, a question identifier to identify the user input control to be included in the section, and the display page includes two or more sections;
computer code executable with the processor comprising:
a container detail module executable to receive a container detail, the container detail comprising a question identifier value and a page identifier value; and
a container generation module executable to generate the container detail entry in the application database from the container detail, wherein the question identifier corresponds to the question identifier value and the page identifier corresponds to the page identifier value.

2. The container generation system of claim 1, wherein the application database further comprises question detail entries to configure user input controls included in the section of the display page of the customizable application, wherein the container detail entry comprises question identifiers to identify the user input controls to include in the section, and wherein the container detail entry comprises a set of question identifier values, and the set of question identifier values correspond to the question identifiers.

3. The container generation system of claim 2, wherein the set of question identifier values is an ordered set, and the container generation module is further executable to generate the corresponding question identifiers in a same order as the set of question identifier values to configure a display order of the user input controls.

4. The container generation system of claim 1, wherein the container generation module is further executable to generate a new container detail entry and to replace the container detail entry with the new container detail entry.

5. The container generation system of claim 1, wherein the container generation module is executable to generate the container detail entry based on privileges of a user.

6. The container generation system of claim 1, wherein the question detail entry comprises user input control configuration parameters to configure the user input control, and the container detail entry comprises a subset of the user input control configuration parameters configured to selectively override the user input control configuration parameters to adjust configuration of the user input control included in the section.

7. A container generation system for a customizable application, the container generation system comprising:
a processor;
a display in communication with the processor; and
a memory storage device in communication with the processor, the memory storage device including computer code, the computer code executable with the processor and comprising:
code executable to retrieve from an application database, and to display in the display, a container detail entry, wherein the application database is configurable to customize a customizable application, and the customizable application includes at least two display pages;
code executable in response to a user input to configure the displayed container detail entry to customize a section of a display page of the customizable application, wherein the section includes a user input control, a question detail entry included in the application database is configurable to customize the user input control, and the display page comprises two or more sections;
code executable to retrieve from the application database, and to display in the display, a question display rule entry;
code executable in response to the user input to configure the displayed question display rule entry to customize a question display rule, wherein the user input control is displayed on the display page based on the question display rule, the question display rule entry comprises a question display rule name, the container detail entry includes a question display rule identifier to identify the question display rule entry, and the container detail entry further includes a question identifier to identify the question detail entry; and
code executable to display in the display the question identifier and the display rule name.

8. The container generation system for the customizable application of claim 7, wherein the question display rule comprises a plurality of display rules and at least one Boolean operator, wherein the display rules are operands of the at least one Boolean operator and, together with the at least one Boolean operator, form a Boolean expression, wherein each of the display rules is represented in the Boolean expression by a rule name of each of the display rules, and wherein the display rule name is the Boolean expression.

9. The container generation system for the customizable application of claim 8, wherein the computer code further comprises code executable to add a Boolean operator and a display rule to the question display rule in response to a user selection of the Boolean operator and the display rule, and code executable to modify the question display rule entry to reflect modifications made to the question display rule.

10. The container generation system for the customizable application of claim 7, wherein the computer code further comprises code executable to modify the displayed question display rule entry in response to a user input.

11. The container generation system for the customizable application of claim 10, wherein the computer code further comprises code executable to indentify a syntax error in the question display rule.

12. The container generation system for the customizable application of claim 8, wherein the Boolean expression is a first Boolean expression, and each of the display rules represented in the first Boolean expression is a second Boolean expression.

13. The container generation system for the customizable application of claim 7, wherein the customizable application is configurable to display the section of the display page only if the user input control is displayed.

14. In a computer system comprising a graphical user interface including a display and a selection device, a method of configuring a customizable application, the method comprising:
retrieving from an application database a first set of question identifiers associated with a container, wherein the container is a section of a display page of the customizable application, each question identified by the question identifiers of the first set is represented by a user input control positioned within the section of the display page, the display page comprises at least two sections, and the customizable application includes at least two display pages;
displaying on the display at least one of the question identifiers of the first set;
receiving a button selection signal from the selection device indicative of a first user selection of an add question button;
retrieving from the application database a second set of question identifiers unassociated with the container;
displaying on the display the second set of question identifiers;
receiving a question selection signal from the selection device indicative of a second user selection of a third set of question identifiers from the second set of question identifiers;
updating the application database to also associate the third set of question identifiers with the container;
receiving a page selection signal from the selection device indicative of a third user selection of a page identifier from a list of page identifiers, wherein the page identifier identifies the display page, and the display page includes at least two containers identified by container identifiers; and
receiving a container selection signal from the selection device indicative of a fourth user selection of a container identifier from the container identifiers, wherein the container identifier identifies the container.

15. The method of claim 14, further comprising an initial step of verifying whether a current user has privileges to configure the container.

16. The method of claim 14, wherein the first set of question identifiers is an empty set.

17. The method of claim 14, further comprising receiving an application selection signal indicative from the selection device indicative of a fifth user selection of an application identifier from a list of a plurality of applications implemented with the customizable application.

18. The method of claim 14, further comprising:
displaying on the display a question identifier unassociated with the container;
receiving an add to container selection signal from the selection device indicative of a fifth user selection of an add to container button; and
adding the question identifier to the first set of question identifiers.
